(19) United States
(12) Patent Application Publication
(10) Pub. No.: US 2008/0175190 A1
(43) Pub. Date: Jul. 24, 2008

(54) Multi-node media content distribution system

(75) Inventors: Kah Yong Lee, Singapore (SG); Ping Soon Kwok, Singapore (SE); Tai Chew Tan, Singapore (SG)

Correspondence Address: George O Saile and Assocs, 28 Davis Ave, Poughkeepsie, NY, 12603, US

(73) Assignee: FreeSystems Pte., Ltd.

(21) Appl. No.: 12/006,952

(22) Filed: Jan. 8, 2008

Related U.S. Application Data
(60) Provisional application No. 60/879,173, filed on Jan. 8, 2007.
(60) Provisional application No. 60/879,172, filed on Jan. 8, 2007.
(60) Provisional application No. 60/879,174, filed on Jan. 8, 2007.

(51) Int. Cl. H04Q 7/00

(52) U.S. Cl. 370/328

(57) ABSTRACT

A multi-node media content distribution system is incorporated in portable slave node media content reproduction devices for sharing video, music, photo or any other media content files with other portable slave node media content reproduction devices wirelessly. The multi-node media content distribution system includes media content reproduction devices wirelessly configured as a network. One of the media content reproduction devices is designated as a master controller node media content reproduction device and provides the media content files to the network as a server. All remaining media content reproduction devices are slave nodes to the master controller node media content reproduction device to receive the media content files. The master controller node media content reproduction device encrypts the media content files with a unique encryption key that is known only to the member slave. Each of the media content reproduction devices of the network may be in communication with an online music store for purchase of a media content file based on its associated media content information file.

This application claims priority under 35 U.S.C. §119 to U.S. Provisional Patent Application Ser. No. 60/879,173, Filing Date: Jan. 8, 2007 which is herein incorporated by reference in its entirety.

### RELATED PATENT APPLICATIONS

“A Multi-Node Media Content Relay System”, Number Ser. No. 60/879,172, Filing Date: Jan. 8, 2007, assigned to the same assignee as this invention and incorporated herein by reference in its entirety.

“A Wireless Network for Personal Computer Human Interface Devices”, Number Ser. No. 60/879,174, Filing Date: Jan. 8, 2007, assigned to the same assignee as this invention and incorporated herein by reference in its entirety.

### BACKGROUND OF THE INVENTION

1. Field of the Invention

This invention relates generally to data network systems. More particularly this invention relates to network systems for the transfer of media content data files from a master control node media content reproduction device to remote slave node media content reproduction devices of the network.

2. Description of Related Art

Wireless networks such as the Bluetooth network allow the communication between portable and remote electronic devices, such as notebook computers, mobile phones, personal digital assistants (PDA's), digital cameras, and mp3/MD/DVD players. Digital media content files such as digitized audio (music and voice) and video files are transferred between the portable and remote electronic devices.

“Bluetooth: An Enabler for Personal Area Networking”, Johansson, et al., IEEE Network, September/October 2001, Vol.: 15, Issue: 5, pp.: 28-37, describes use of portable electronic devices in a network of personal devices that is often referred to as a personal area network. The Bluetooth piconet network architecture, a strict star topology, is extended into a scatternet architecture, where piconets are interconnected. A consequence of creating scatternet-based personal area networks is that some nodes will form gateways between piconets, and these gateways must be capable of time sharing their presence in each piconet of which they are members. Johansson et al. presents an overall architecture for handling scheduling in a scatternet. A family of feasible inter-piconet scheduling algorithms, referred to as rendezvous point algorithms, is also introduced and discussed.

“Bluenet—A New Scatternet Formation Scheme”, Wang et al., Proceedings of the 35th Annual Hawaii International Conference on System Sciences, IEEE Computer Society, January 2002, 9 pages (not numbered), presents a scheme for building an efficient scatternet and discusses the basic rules of the scheme. Two methods are introduced to evaluate the performance of the resulting scatternets based on average shortest path length and maximum traffic flows respectively.

“Interconnecting Bluetooth-like Personal Area Networks”, Tan, 1st Annual Oxygen Workshop, Gloucester, Mass., 2001, found Feb. 1, 2007 at http://nms.csail.mit.edu/projects/blueware/oxygen01.pdf, identifies the three main challenges in interconnecting multiple Bluetooth-like PAN's: scatternet topology formation, packet routing, and channel or link scheduling. The need for an explicit topology formation process stems from the fact that devices need to discover each other and explicitly establish a point-to-point link to synchronize the frequency hopping sequence and exchange signaling information. Once the scatternet is formed, some mechanism is required to efficiently route packets across multiple PAN's. The scheduling problem arises because channel bandwidth must be used efficiently, and the time division duplex nature introduces problems not seen in traditional wireless channel scheduling.

“A Priority Control Method for Wireless Multi-Hop Access Using IEEE 802.11 DCF Mechanism” Kawamura, et al., 15th IEEE International Symposium on Personal, Indoor and Mobile Radio Communications, 2004, PIMRC 2004, September 2004, Vol.: 1, pp.: 520-524 explains the problem of throughput degradation of a relay station when IEEE 802.11 is adopted in multi-hop communications. The relay stations lose some of their capacity compared to stations that are not relaying the data of other stations. Because all stations have equal transmission opportunity, the relay stations have to send packets from other terminals. An autonomous priority control method is proposed that changes the contention window size depending on the number of relay stations and the number of hops to ensure that relay stations are offered the same transmission capacity as regular stations in the service area.

U.S. Pat. No. 6,795,688 (Plasson, et al.) illustrates the topology of a network of electronic devices that can be coupled using wireless connections coupled in personal area network (PAN) and other devices are coupled in a piconet using wireless connections. Each of the devices in a PAN and piconet can be in communication with each other. By periodic polling, the member devices of PAN determine the state of their surrounding network structure. The method and system for dynamically configuring a device receives an attribute setting corresponding to characteristics of the device and implements a corresponding configuration state. The configuration state activates a corresponding device configuration. The attribute setting constitutes a discretely variable value conforming to the degree of mobility of the device. Alternately, an attribute setting constitutes a discretely variable value conforming to the location of the device.

U.S. Pat. No. 6,845,398 (Galensky, et al.) presents a wireless device, system and method for receiving and playing multimedia files streamed from a multimedia server over a wireless telecommunications network. A desired multimedia file is selected from one or more multimedia files stored in the multimedia server that is connected to the wireless telecommunications network. Successive blocks of data from the desired multimedia file are streamed over the wireless telecommunications network in a digitized and compressed format and received by the wireless telecommunications device. The received blocks of data from the streamed multimedia file are temporarily stored in a buffer in the wireless device, decoded and decompressed, and successively played through an audio and/or video output in the wireless device. The wireless device monitors the blocks of data stored in the buffer and signals the wireless telecommunications network to increase the rate that the data blocks are transmitted over the wireless network in the event that the data stored in the buffer falls below a minimum threshold level.

U.S. Pat. No. 6,928,295 (Olson, et al.), teaches a system and method for facilitating the authentication of wireless devices in an environment with multiple wireless networks. A user wishing to join an operating wireless network can bring his wireless device within close physical proximity, for example, less than one meter, of a device in the network that he wishes to join. The user then presses an authenticate button, which causes both devices to enter a low transmission power mode. In such case, the devices are only capable of operation within the close proximity. Being in low power mode will diminish the possibility of eavesdropping on the authentication process.

U.S. Pat. No. 7,167,678 (Powers) describes persistent peer-to-peer networking over a piconet network. The persistent peer-to-peer network is implemented over a network with master-slave topology. Data being sent from master to slave or from slave to master are sent in one transmission, but data sent from one slave to another is received by the master and retransmitted to the slave. A session table is kept at each device includes an ordered list of devices, where the first device is the master device. When a master device drops out of the network the slave devices promote the next device in the ordered list of devices to master. A master device may also receive a request from a slave device to become master, and update its session table and send the updated session table to all devices. The slave device requesting master status is then treated as master by all devices in the network.

U.S. Pat. No. 7,167,920 (Traversat, et al.) teaches a system and method for establishing communications channels between and among peers in a peer-to-peer networking environment. Pipes may be used as communication channels for sending and receiving messages and other data between services or applications over input and output endpoints. Pipes may be asynchronous, unidirectional, stateless and unreliable. Bidirectional pipes may also be supported. Pipes may have ends that may be moved around and bound to different peers at different times. Point-to-point and propagate pipes may be supported. Pipes may connect peers that have a direct physical link and peers that do not have a direct link. Peers may communicate through pipes without knowing on which peer a pipe endpoint is bound. A message is sent to all peer endpoints currently connected (listening) to the pipe. The set of connected endpoints may be obtained from a pipe service using a pipe binding protocol.

U.S. Patent Application 2005/0107102 (Yoon, et al.), describes an apparatus to relay connection requests between wireless devices in a wireless network including at least one piconet having a master device and one or more slave devices. The apparatus includes a connection request relay unit in the master device to relay to a first wireless device a request from a second wireless device to connect to the first wireless device. The first wireless device is one of the one or more slave devices, and the second wireless device is outside the piconet having the master device.

U.S. Patent Application 2005/0286546 Bassoli, et al. describes methods and apparatus for providing synchronous playback of the same piece of time-based media on multiple devices connected over heterogenous channels consisting of varying degrees of delay. The apparatus employs a peer-to-peer wireless application that allows users to share music locally through handheld devices.

U.S. Patent Application 2006/0039304 (Singer, et al.) provides a method and apparatus for wireless distribution of a file using ad-hoc wireless networks. The method and apparatus for distributes a media content file to a node of the ad hoc network. The received file is then shared with a recognized neighbor node of the ad hoc network. Once the file is provided by a distributor node to a neighbor node, the distributor node claims an incentive for sharing the file with the neighbor node.

### SUMMARY OF THE INVENTION

An object of this invention is to provide a multi-node media content distribution system incorporating media content reproduction devices such as portable media players for sharing video, music, photo or any other media content with other portable slave node media content reproduction devices wirelessly.

Another object of this invention is to provide a network for a multi-node media content distribution system that has a network of multiple media content reproduction devices where one of the media content reproduction devices assumes the function of master controller node for the network and provides the media content data files to the network as a server to other slave portable slave node media content reproduction devices.

To accomplish at least one of these objects, a multi-node media content distribution system distributes media content wirelessly. The multi-node media content distribution system includes a plurality of media content reproduction devices communicating wirelessly. The plurality of media content reproduction devices are configured as a network, where one of the media content reproduction devices is designated as a master controller node media content reproduction device for the network and provides the media content data files to the network as a server. All remaining media content reproduction devices are slaves to the master controller node media content reproduction device to receive the media content data files. The media content data files are digitized musical files, digitized video files, digitized voice messaging files, or text messaging files. The media content data files may have associated media content information files.

The network includes an application layer and a protocol layer. The application layer is structured such that all the media content reproduction devices appear to be able to share their media content data files with other media content reproduction devices in the network. The protocol layer is structured such that the master controller node media content reproduction device coordinates a communication channel access timing and distribution of the media content data files to and from the other slave node media content reproduction devices in the network.

The network of the multi-node media content distribution system functions selectively in a broadcast mode, a server mode, or a peer-to-peer network mode. When the network functions in the broadcast mode, the master controller node media content reproduction device broadcasts the media content data files to the slave node media content reproduction devices of the network. When the network functions in the server mode, each slave node media content reproduction device of the network requests separate media content data files from a media content data files list. The media content data files list contains file names of the media content data files to be transferred from the master controller node media content reproduction device to each of the slave node media content reproduction devices. When the network functions in the peer-to-peer network mode, the user of master controller node media content reproduction device and the slave node media content reproduction devices appear to be equals on a peer-to-peer network. In the peer-to-peer mode, the media content data files list for the master controller node media content reproduction device and all the slave node media content reproduction devices are transferred equally to the master controller node media content reproduction device and all the slave node media content reproduction devices and the master controller node media content reproduction device and all the slave node media content reproduction devices individually request media content data files.

The master controller node media content reproduction device and the slave node media content reproduction devices each have a network controller and a media content storage device. The network controller includes a transceiver for broadcasting the bidirectional communication between the master controller node media content reproduction device and the slave node media content reproduction devices and an antenna connected to the transceiver for broadcasting the bidirectional communication as RF signals. The media content storage device is in communication with the network controller for storing the media content data files.

At initialization, the master controller node media content reproduction device assigns a channel to each individual slave node media content reproduction devices. The assigned channel is a time slot in a time domain multiple access (TDMA) communication system or a separate frequency channel of an RF communication system. The master controller node media content reproduction device receives commands from a user of the master controller node media content reproduction device to select the broadcast mode, the server mode, or the peer-to-peer network mode. When the network functions in broadcast mode, the network controller of the master controller node media content reproduction device extracts a desired media content data file from the media content storage of the master controller node media content reproduction device and broadcasts the media content data files as an uncompressed digitized audio signal as the RF signal from the master controller node media content reproduction device to the slave node media content reproduction devices. The media content data file is divided into transmission frames to be broadcast by the network controller of the master controller node media content reproduction device such that the each transmission frame is divided into digitized audio data sub-frames appended with control and synchronization data sub-frames.

When the network functions in the server mode and the peer-to-peer network mode, the network controller of master controller node media content reproduction device transmits a media content list describing the media content data files present in the media content storage of the master controller node media content reproduction device to each of the slave node media content data files. Each of the slave node media content reproduction devices transmits their media content lists describing the media content data files present in the media content storage of the slave node media content reproduction devices to the master controller node media content reproduction device. The master controller node media content reproduction device then compiles the media content lists of the slave node media content reproduction devices and retransmits the compiled media content lists to all the slave node media content reproduction devices. When the master controller node media content reproduction device receives a request for media content data files resident on one of the slave node media content reproduction devices, the master controller node media content reproduction device requests the media content data files from the slave node media content reproduction devices retaining the requested file in its media content storage. The network controller of the slave node media content reproduction device possessing the requested media content data files extracts the request media content data files from its media content storage device and transmits the media content data files to the master controller node media content reproduction device. The master controller node media content reproduction device retransmits the requested media content data file to the requesting slave node media content reproduction device.

When the network functions in the server mode, the master controller node media content reproduction device acts as strictly a server providing the media content data files residing in the media content storage of the master controller node media content reproduction device.

The master controller node media content reproduction device monitors a digital rights management of the media content data files and will not store or retrieve the media content data files retained by the media content storage, if doing so violates digital rights management agreements between authors of the media content data files and the users of the master controller node media content reproduction device and the users of the slave node media content reproduction devices.

The master controller node media content reproduction device encrypts the media content data files with a unique encryption key that is known only to the member media content reproduction devices of the multi-node media content distribution system to prevent, interception of the transmitted media content data files. One of the media content reproduction devices of the multi-node media content distribution system provides the permission to share the media content data files and the plurality of media content reproduction devices negotiate and exchange the encryption key.

Each of the plurality of media content reproduction devices of the network may be in communication with an online music store. One slave node media content reproduction device receives one media content data file and an associated media content information file from the master controller node media content reproduction device. Upon reproduction of the media content data file, the user of the one slave node media content reproduction device stores the associated media content information file. When the users desires to purchase the one media content data file, the user of the one slave node media content reproduction device receiving the one media content data file selectively transfers the associated media content information file to the online music store to purchase the one media content data file designated of the associated media content information file.

The user of the one media content reproduction device that originally transferred the one media content data file receives store credit for the purchase of the one media content reproduction device for sharing the one media content data file. The user of the one slave node media content reproduction device receiving the one media content data file receives store credit for purchasing the one media content reproduction device as a result of sharing the one media content data file.

At least one of the plurality of media content reproduction devices of the multi-node media content distribution system is in communication with an online music store wirelessly through a public or private communications network connected to the internet with the online music store connected to the internet. Alternately, at least one of the plurality of media content reproduction devices of the multi-node media content distribution system is in communication with an online music store through a link to a personal computer connected to the internet with the online music store connected to the internet, wherein the at least one of the plurality of media content reproduction devices is connected as an input/output device of the personal computer.

### BRIEF DESCRIPTION OF THE DRAWINGS

FIG. 1 is a block diagram of a multi-node media content distribution system of this invention.

FIGS. 2a-2c are flow diagrams of a method for media content distribution of this invention.

FIG. 3 is a block diagram of a second embodiment of a media content distribution system of this invention.

FIG. 4 is a flow diagram of an embodiment of a method for purchase of multi-node content through a multi-node media content distribution system of this invention.

FIG. 5 is a flow diagram of another embodiment of a method for purchase of multi-node content through a multi-node media content distribution system of this invention.

### DETAILED DESCRIPTION OF THE INVENTION

A multi-node media content distribution system of this invention is multiple media content reproduction device such as a portable media players for wirelessly sharing video, music, photo or any other media content with other slave node media content reproduction devices. The multi-node media content distribution system forms a multimode network where one of the slave node media content reproduction devices assumes the function of master controller node for the network and provides the media content data files to the network as a server. The other slave node media content reproduction devices are slaves to the master controller node and receive the media content data files. The media content data files is compressed or uncompressed digitized audio or video files or digital photographs that are available for sharing.

The multi-node media content distribution system of this invention is divided into two layers: an application layer and a protocol layer. In the application layer, all the slave node media content reproduction devices appear to be able to share their content with other slave node media content reproduction devices in the network. Whereas, in the underlying protocol layer, there will only be one master controller node media content reproduction device, who will coordinate the channel access timing and distribution of the media content data files to and from the other slave node media content reproduction devices in the network. This allows the network to operate in three different modes. The first mode is a broadcast mode where the master controller node media content reproduction device broadcasts the media content data files to the slave node media content reproduction devices of the network. The second mode is a server mode where each slave node media content reproduction device of the network requests separate media content data files from a media content data files list containing the file names of the media content data files list transferred from the master controller node media content reproduction device to each of the slave node media content reproduction devices. The third mode is appears as a peer-to-peer network where the user of master controller node media content reproduction device and the users of the slave node media content reproduction devices appear to be equals on a peer-to-peer network. The media content data files list for the master controller node media content reproduction device and all the slave node media content reproduction devices are now transferred equally to the master controller node and all the slave node media content reproduction devices and the master controller node media content reproduction device and all the slave node media content reproduction devices can individually request media content data files.

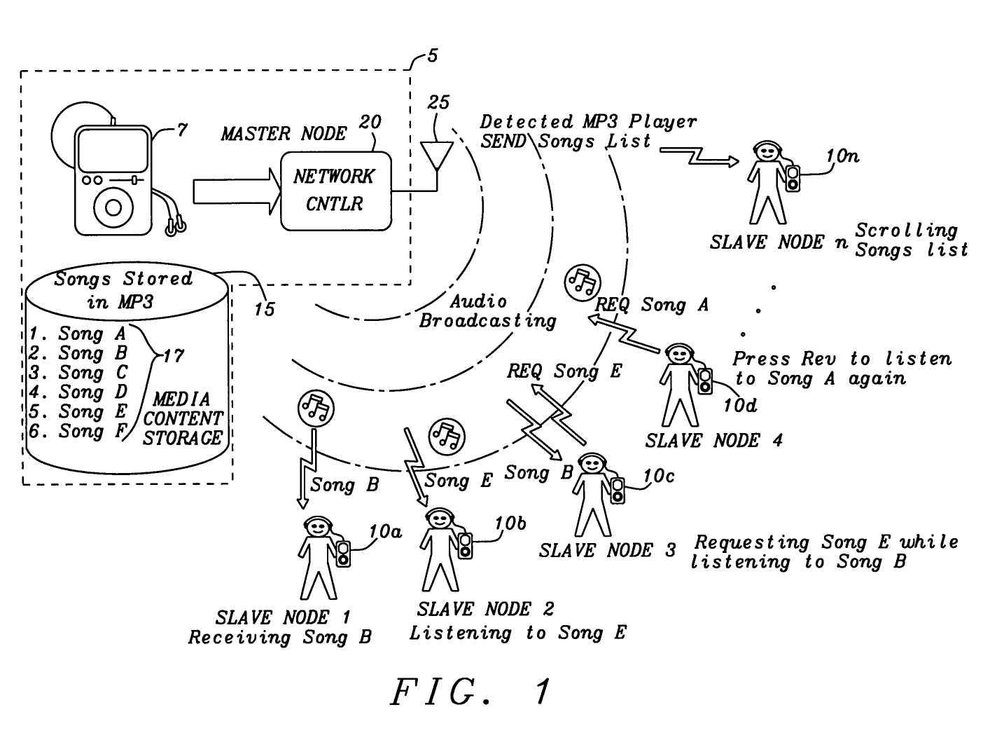

Refer now to FIG. 1 for a detailed description of the multi-node media content distribution system of this invention. A group of slave node media content reproduction devices are organized into the multi-node media content distribution system of this invention. When the slave node media content reproduction devices are in sufficiently close proximity to each other, one of the slave node media content reproduction devices become the master controller node slave node media content reproduction device 5 that will act as a the server for the network and the remaining slave node media content reproduction devices become the slave nodes 10a, 10b, . . . , and 10n.

The master controller node media content reproduction device 5 has a media content storage 15 that contains all the media content data files of the master controller node media content reproduction device 5. The media player 7 of the master controller node media content reproduction device 5 can play any of the media content data files 17 when the user of the slave node media content reproduction device desires. The master controller node media content reproduction device 5 has a network controller 20 that provides the command, control, formatting, and transmission of the media content data files from the media content storage 15 to the slave node media content reproduction devices 10a, 10b, . . . , and 10n. The master controller node media content reproduction device 5 and the slave node media content reproduction devices 10a, 10b, and 10n each have a network controller 20 included that permits bidirectional communication between the master controller node media content reproduction device 5 and the slave node media content reproduction devices 10a, 10b, . . . , and 10n. The master controller node media content reproduction device 5 in its initialization assigns a channel to each individual slave node media content reproduction device 10a, 10b, . . . , and 10n. The channel may be a time slot in a time domain multiple access (TDMA) communication system or a separate frequency channel of an RF communication system.

As noted above, the multi-node media content distribution system of this invention functions in three modes. The network controller 20 based on the commands from the user of the slave node media content reproduction device establishes itself in the desired mode. In broadcast mode, the network controller 20 will extract the desired media content data file from the media content storage 15 and broadcast it as an uncompressed digitized audio signal to the slave node media content reproduction devices 10a, 10b, . . . , and 10n. In the broadcast mode only one media content data file is broadcast as chosen by the user of the master controller node media content reproduction device 5. Each transmission frame from the network controller 20 is divided into digitized audio data sub-frames and control and synchronization data sub-frames.

In the server mode and the peer-to-peer network mode, network controller 20 transmits a media content list describing the media content data files present in the media content storage 15 of the master controller node media content reproduction device 5 to each of the slave node media content reproduction devices 10a, 10b, . . . , and 10n. For the peer-to-peer network mode, each of the slave node media content reproduction devices 10a, 10b, . . . , and 10n transmits their media content lists describing the media content data files present in the media content storage of the slave node media content reproduction devices 10a, 10b, . . . , and 10n. The network controller 20 then compiles the media content lists of the slave node media content reproduction devices 10a, 10b, and 10n and retransmits them to all the slave node media content reproduction devices 10a, 10b, . . . , and 10n. In the server mode, the master controller node media content reproduction device 5 acts as strictly a server providing on the media content data files residing in the media content storage 15. In the peer-to-peer network mode, the network controller 20, receives a request for media content data files resident on one of the other slave node media content reproduction devices 10a, 10b, . . . , and 10n. The network controller 20 requests the media content data file from the slave node media content reproduction device 10a, 10b, . . . , and 10n retaining that file in its media content storage. The slave node media content reproduction device 10a, 10b, . . . , and 10n includes a network controller similar to that of the master controller node media content reproduction device 5 which extracts the request media content data file and transmits it to the master controller node media content reproduction device 5. The network controller 20 retransmits the requested media content data file to the requesting slave node media content reproduction device 10a, 10b, . . . , and 10n.

The network controller 20 will divide the transmission frame designated for each slave node media content reproduction device 10a, 10b, . . . , and 10n into multiple time slots. One time slot of the transmission from will contain a portion of the content media data file. The network controller 20 will transmit as many transmission frames as necessary to transmit the content media data file. The network controller 20 will provide the necessary synchronization and channel access control for the transmission frames. In the server mode and the peer-to-peer network mode, compressed content media data files are transmitted due to bandwidth limitations. The division of the transmission frames into multiple time slots allows multiple media content data files to multiplex for simultaneous transmission.

The network controller 20 further monitors the digital rights management of the media content data files and will not store or retrieve files retained by the media content storage 15, if doing so violates the digital rights management agreements between the authors of the media content data files and the users of the master controller node media content reproduction device 5 slave node media content reproduction device and the users of the slave node media content reproduction devices 10a, 10b, . . . , and 10n. Also, to prevent, interception of the transmitted media content data files, the network controller 20 encrypts the media content data files with a unique encryption key (ID) that is known only to the member slave node media content reproduction devices of the multi-node media content distribution system of this invention. The users of the master controller node media content reproduction device 5 and/or the slave node media content reproduction devices 10a, 10b, . . . , and 10n will give the permission to share the media content data files. The network controllers 20 of each of the master controller node media content reproduction device 5 and the slave node media content reproduction devices 10a, 10b, . . . , and 10n employing the underlying communication protocol will negotiate and exchange the encryption key. Any undesired third party will not be able to “sniff” the content since it will not be able to acquire the encryption key.

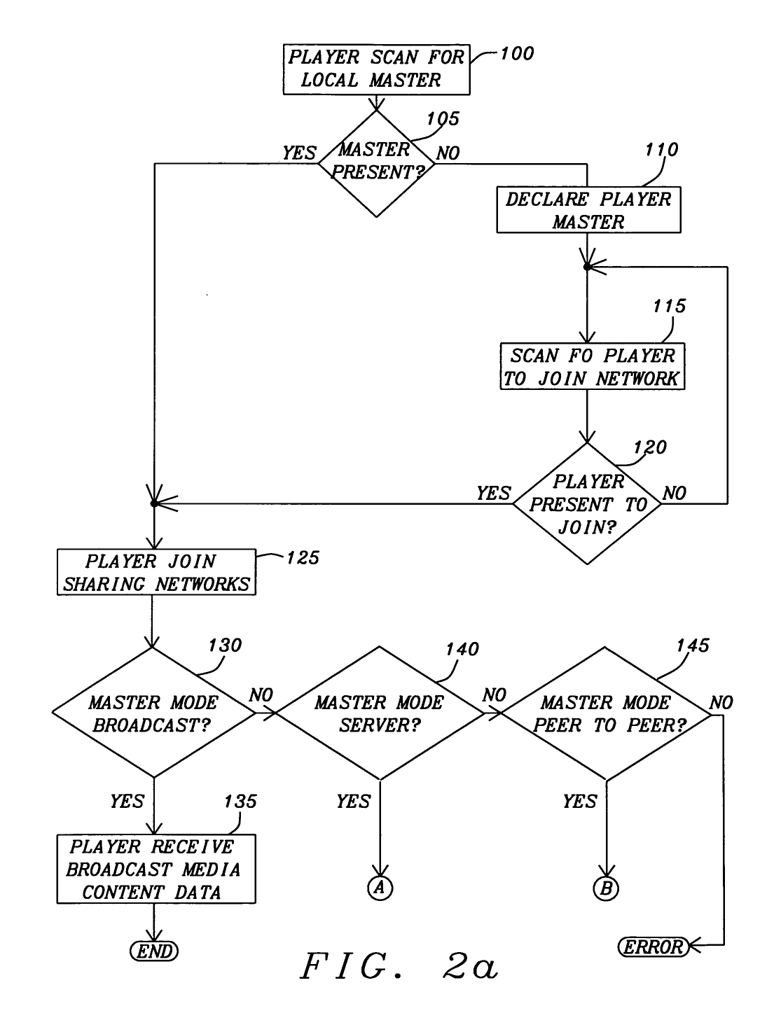

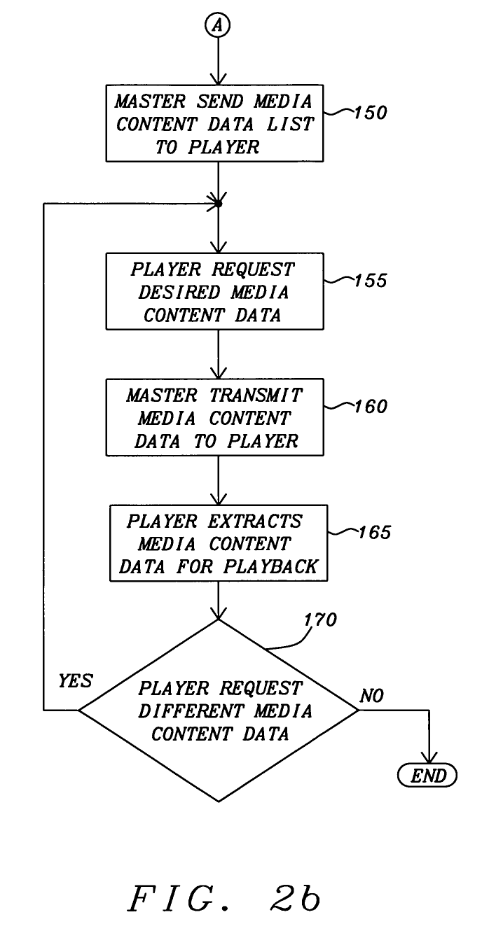

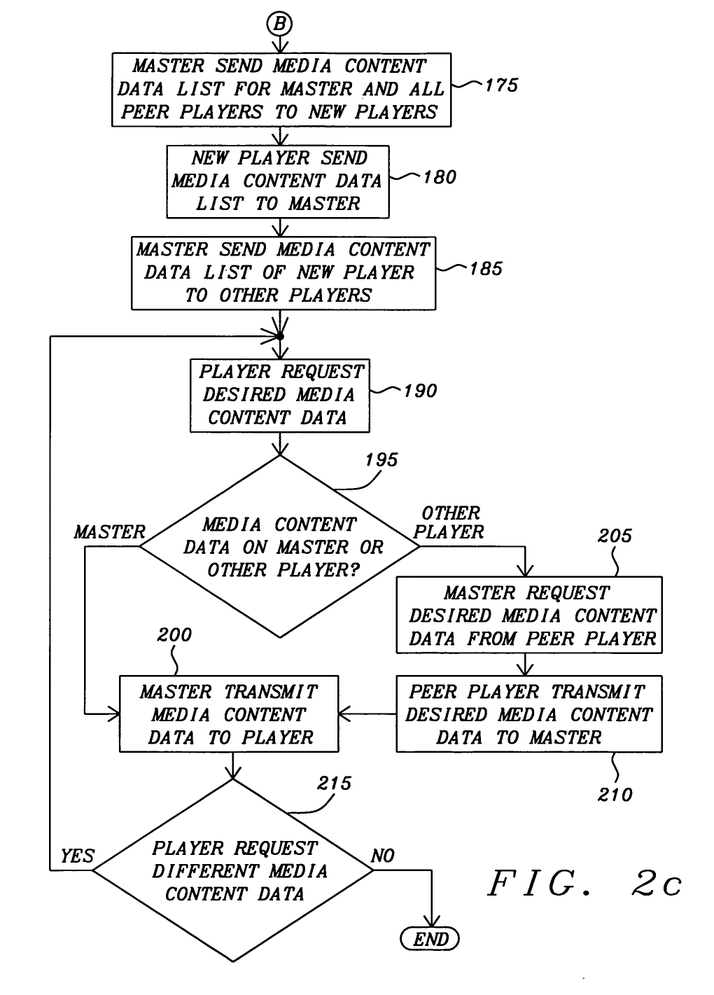

Refer now to FIGS. 2a-2c for a description of the method for distributing media content data files in a multi-node media content distribution system of this invention. A slave node media content reproduction device monitors the RF channels on which a multi-node media content distribution network is transmitting and receiving polling signals to scan (Box 100) for a local master controller node. The slave node media content reproduction device determines (Box 105) if a master controller node is present. If not, the slave node media content reproduction device declares (Box 110) itself as a master controller node and begins to transmit and receive polling signals to identify itself as a master node of a multi-node media content distribution system of this invention. The master controller node scans (Box 115) for the presence of other slave node media content reproduction devices present to join media content distribution system network. The master controller node media content reproduction device determines (Box 120) if another slave node media content reproduction device is present. If not the master controller node media content reproduction device continues to scan (Box 115) if a slave node media content reproduction device is present. When a slave node media content reproduction device is present, the master controller node media content reproduction device and the media content reproduction device establish time slot for TDMA transmission or RF channel for RF transmission, the encryption code, the master controller nodes operation mode, and other operational information to allow the slave node media content reproduction device to join (Box 125) the media content distribution network as a slave node media content reproduction device. The slave node media content reproduction device then determines (Box 130) if the mode is for a broadcast mode. If the master controller node media content reproduction device is in the broadcast mode, the slave node media content reproduction device receives (Box 135) the broadcast media content data files for playback. If the master node media content reproduction device is not in the broadcast mode, the slave node media content reproduction device then determines (Box 140) if the master controller node media content reproduction device is in the server mode. If the master controller node media content reproduction device transmits (Box 150) a media content data file list detailing the content media data files retained by the master controller node media content reproduction device on its media content storage. The slave node media content reproduction device requests (Box 155) the desired media content data files for playback. The master controller node media content reproduction device formats the media content data file, optionally encrypts the data to be transmitted, appends the necessary synchronization signals, and transmits (Box 160) the content media data to the requesting slave node media content reproduction device. For a multi-node media content distribution system with many nodes each slave node media content reproduction device may request individual media content data files for itself. The data transmission frames to be transmitted are divided into smaller time slots and the content media data for each requesting slave node media content reproduction device is placed into an assigned time slot. The slave node media content reproduction device receives the signal and extracts (Box 165) only the content media data that it requested. The slave node media content reproduction device determines (Box 170) if the user desires that the content media data be replayed or if a new file is to be requested. If a new file is to be requested, the new file is requested (Box 155), formatted, transmitted (Box 160) by the master controller node media content reproduction device, and received and extracted (Box 165) by the slave node media content reproduction device for playback. If the user does not request new content media data, the process is ended.

If the slave node media content reproduction device determines (Box 140) that the master controller node media content reproduction device is not in the server mode, the slave node media content reproduction device then determines (Box 145) is the master controller node media content reproduction device is in the peer-to-peer network mode. If it is not in any of the three modes, broadcast, server or peer-to-peer network, there is an error in the slave node media content reproduction device and it is declared as such. If the master controller node is in the peer-to-peer network mode, the master controller node media content reproduction device sends (Box 175) the media content data file list for the master controller node media content reproduction device and for all the peer media content reproduction devices present on the multi-node media content distribution system. The master controller node media content reproduction device requests and the new slave node media content reproduction device sends (Box 180) is media content data file list to the master controller node media content reproduction device. The master controller node media content reproduction device then retransmits (Box 185) the media content data file list of the new slave node media content reproduction device to all peer media content reproduction devices present on the multi-node media content distribution system. A peer media content reproduction device requests (Box 190) its desired media content data files. The master controller node media content reproduction device determines (Box 195) if the desired is resident on the master controller node media content reproduction device or one of the other peer media content reproduction devices. If it is present on one of the other peer media content reproduction device, the master controller node media content reproduction device requests (Box 205) the desired media content from the peer media content reproduction device. The peer media content reproduction device transmits (Box 210) the desired media content data files to the master controller node media content reproduction device.

If the desired media content data files is resident on the master controller node media content reproduction device or has been transmitted (Box 210) to the master controller node media content reproduction device, the master controller node media content reproduction device transmits (Box 200) the desired media content data files to the requesting peer media content reproduction device. The slave node media content reproduction device determines (Box 215) if the user desires that the content media data be replayed or if a new file is to be requested. If a new file is to be requested, the new file is requested (Box 190), its location is determined (Box 195), if it is resident on a another peer media content reproduction device, the media content data files is requested (Box 205), the media content data files is formatted and transmitted by the peer media content reproduction device to the master controller node media content reproduction device, transmitted (Box 160) by the master controller node media content reproduction device, and received and extracted (Box 165) by the slave node media content reproduction device for playback. If the user does not request new content media data, the process is ended.

An alternative to the transmission of the media content data files from the peer media content reproduction device to the master controller node media content reproduction device and retransmission to the requesting peer media content reproduction device, is for the peer media content reproduction device to request allocation of a time slot within the transmission frame in which the peer media content reproduction device transmits directly to the requesting peer media content reproduction device. This eliminates transmission and retransmission of the media content data files, while the master controller node media content reproduction device maintains control of the format, encryption, and transmission of the media content data files.

The media data content as describe above is generally digitized audio and video files or digitized photographic files. Alternately, many of the slave node media content reproduction devices such as personal digital assistants and advanced cellular telephones include microphones for digitally capturing audio such as speech and keypads for creating immediate messaging notes. This facility allows for the intercommunication of the users of the slave node media content reproduction devices that make up the multi-node media content distribution system of this invention to communicate in real time while playing their requested media content data files. The multi-node media content distribution system of this where the master controller node media content reproduction device and the slave node media content reproduction devices share media content data files as a sharing group or community. The sharing parties are able to interact with each other via messaging or voice functions. The user of slave node media content reproduction devices can share their comments and opinion with the masters and other slave node media content reproduction device community members. The master controller node media content reproduction device and the slave node media content reproduction devices will provide input devices such as microphones and keypads as well as display device for messaging function. The master and slave node media content reproduction devices are able to exchange online social networking information as media content data files that contain the audio, video, and/or text messages that enable the extension of the networking function after the music sharing session.

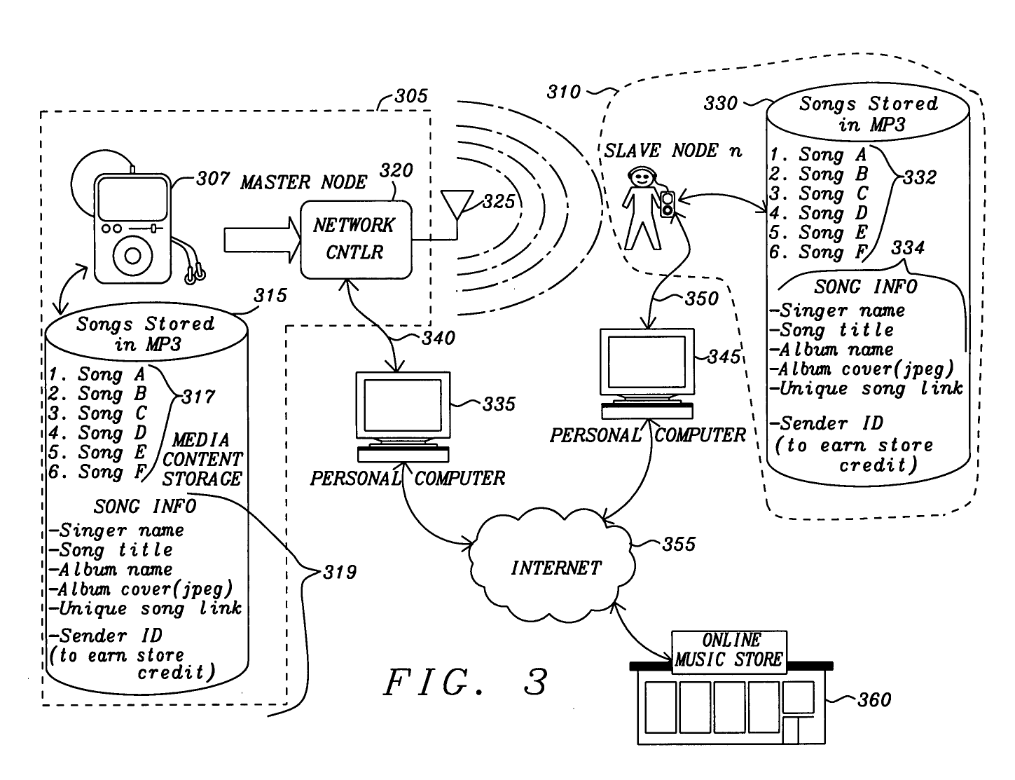

Refer now to FIG. 3 for a description of another embodiment of the multi-node media content distribution system of this invention. A group of slave node media content reproduction devices are organized into the multi-node media content distribution system of this invention similar to that of FIG. 1. When the slave node media content reproduction devices are in close proximity to each other, one of the slave node media content reproduction devices declares itself the master controller node media content reproduction device 305 that will act as a the server for the multi-node media content distribution system and the remaining slave node media content reproduction devices become the slave node media content reproduction devices 310n. It should be noted that the single slave node media content reproduction device 310n is representative of one or many media content reproduction devices that join the network of the multi-node media content distribution system as slave node media content reproduction devices 310n.

The master controller node media content reproduction device 305 has a media content storage 315 that contains all the media content data files of the master controller node media content reproduction device 305. The slave node media content reproduction device 307 of the master controller node-media content reproduction device 305 can play any of the media content data files 317 when the user of the master controller node media content reproduction device 305 desires. The master controller node media content reproduction device 305 has a network controller 320 that provides the command, control, formatting, and transmission of the media content data files from the media content storage 315 to the slave node media content reproduction devices 310n. The master controller node media content reproduction device 305 and the slave node media content reproduction devices 310n each have a network controller 320 included that permits bidirectional communication between the master controller node media content reproduction device 305 and the slave node media content reproduction devices 310n. The master controller node media content reproduction device 305 in its initialization assigns a channel to each individual slave node media content reproduction device 310n. The channel may be a time slot in a time domain multiple access (TDMA) communication system or a separate frequency channel of an RF communication system.

As described in FIG. 1, the multi-node media content distribution system of this embodiment functions in three modes—Broadcast mode, server mode, and peer-to-peer network mode. The network controller 320 based on the commands from the user of the slave node media content reproduction device establishes itself in the desired mode and the media content data files are transferred for reproduction by the master controller node media content reproduction device 305 and the slave node media content reproduction devices 310.

When the master controller node media content reproduction device 305 transfers the media content data files to its slave node media content reproduction devices 310, it will also share the media content data file information 319 at the same time. The example shown illustrates the media content data file information 319 for digital musical audio files. It includes the performing artist's name, the name of the song, the name of the album containing the song, a picture of the album cover in a digitized graphic file format (i.e. jpeg), and a unique song link. The song link is an identifier code used by an online music store 360 such as the Zune Marketplace, a product of Microsoft, Inc, Redmond, Wash. 98052 or iTunes, a product of Apple, Inc. Cupertino, Calif. 95014 to identify the song. The unique song link allows the user of the media content reproduction device desiring to purchase the media content data files from online or a conventional media provider directly.

In the case of digital musical audio files, the master controller node media content reproduction device 305 broadcasts the selected digitized musical audio media content data files 317 as well as the media content data file information 319 simultaneously. The slave node media content reproduction devices 310 display the media content data file information 319 on the slave node media content reproduction device's 310 display unit while listening to the shared selected digitized musical audio media content data files 317. The slave node media content reproduction devices 310 saves the media content data file information 319 (but not the selected digitized musical audio media content data files 317) to the media content storage device 330, if user choose to do so. The media content data file information 319 allows the user of the slave node media content reproduction devices 310 to purchase the song from the online music store 360 at a later stage. Store credit may be provided to the sender (master controller node media content reproduction device 305 or one of the other slave node media content reproduction devices 310 of a peer-to-peer network mode) as the incentive for sharing music. Similarly, store credit may be awarded to the receiver (slave node media content reproduction devices 310) as the incentive to purchase music under music sharing mode.

In the broadcast mode and the server mode, the music being shared or transferred to the media content reproduction devices 310 originate with the master controller node media content reproduction device 305. The selected digitized musical audio media content data files 317 and the media content data file information 319 being stored on the media content storage 315 of the master controller node media content reproduction device 305. In the peer-to-peer network mode, the selected digitized musical audio media content data files 332 of each of the slave node media content reproduction devices 310 is stored in the media content storage device 330 with the media content data file information 334. In the peer-to-peer network mode, the requested selected digitized musical audio media content data files 332 and media content data file information 334 are transferred to the master controller node media content reproduction device 305. When a selected digitized musical audio media content data file 317 or 332 is requested, the copy of the selected digitized musical audio media content data file 317 or 332 with its media content data file information 319 or 334 is transferred to the requesting slave node media content reproduction device 310. At the completion of the reproduction of the selected digitized musical audio media content data files (playing the song), the slave node media content reproduction device 310 is able to store the media content data file information 334 with its unique song link that is the identifier code used by an online music store 360, while sharing the song.

A purchase of a selected digitized musical audio media content data file 317 or 332 by a media content reproduction device 305 or 310 is accomplished by either a wireless network connection to the internet 355 or through a direct connection to a personal computer 335 or 345. The connection 340 from the master controller node media content reproduction device 305 to the personal computer 335 may be a wireless local area network (LAN) or a single direct connection. It the case of the wireless LAN, the master controller node media content reproduction device 305 may have direct connection to the internet 355. In the case of the direct connection, master controller node media content reproduction device 305 as an input/output device for the personal computer 335. The personal computer 335 has a connection to the internet 355.

Identical to the structure of the master controller node media content reproduction device 305, the connection 345 from the slave node media content reproduction devices 310 to the personal computer 345 may be a wireless local area network (LAN) or a single direct connection. It the case of the wireless LAN, the slave node media content reproduction devices 310 may have direct connection to the internet 355. In the case of the direct connection, slave node media content reproduction devices 310 as an input/output device for the personal computer 345. The personal computer 345 has a connection to the internet 355.

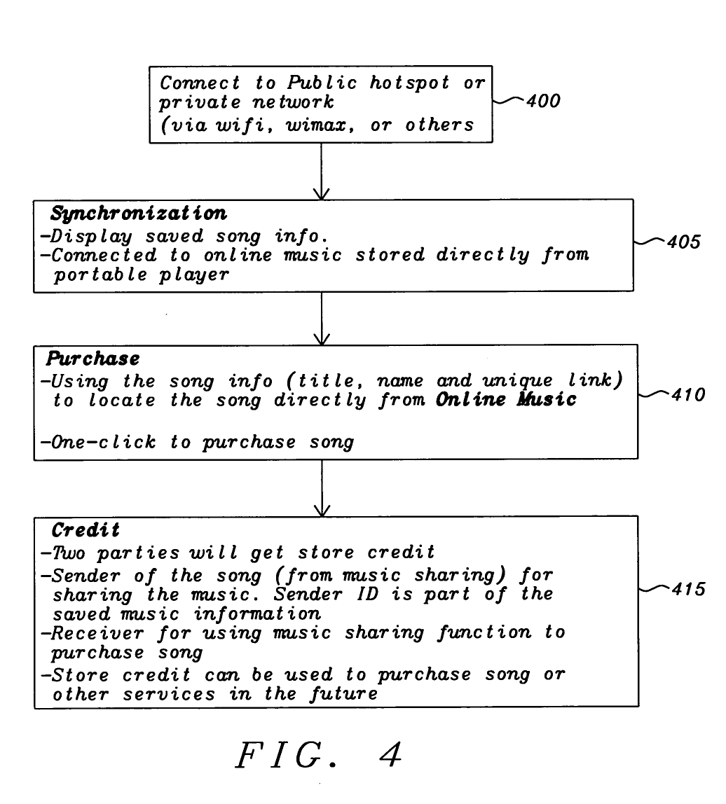

Refer now to FIGS. 3 and 4 for the discussion of the case of the wireless network connection. The user of media content reproduction device 305 or 310 connects (Box 400) through a wireless LAN in public hotspot or private network to the internet 355. The wireless network connection 340 or 345 is possible during the sharing session or after the sharing session, depending on the network capabilities of the media content reproduction device 305 or 310. The media content reproduction device 305 or 310 that is to purchase the selected digitized musical audio media content data file 317 or 332 is synchronized and connected directly (Box 405) with the online music store 360. The unique song link information of the media content data file information 319 or 334 is transferred from the media content reproduction device 305 or 310. The unique song link information of the media content data file information 319 or 334 allows the user to purchase (Box 410) the song directly from the online music store 360. Once the purchase is completed, the user of the media content reproduction device 305 or 310 on which the selected digitized musical audio media content data file 317 or 332 is resident (Box 415) may receive store credit for his effort in sharing the selected digitized musical audio media content data file 317 or 332. The user of the media content reproduction device 305 or 310 that purchases the selected digitized musical audio media content data file 317 or 332 may also get store credit for using sharing concept to purchase song. This store credit allows the users to make music purchase in the future.

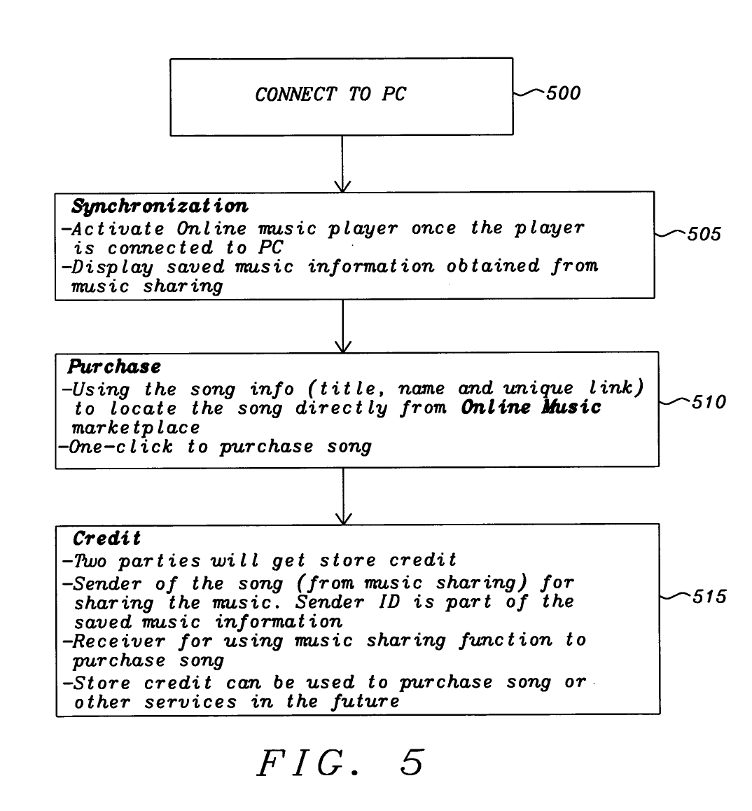

Refer now to FIGS. 3 and 5 for a discussion of the case of the direct connection (Box 500) of the media content reproduction device 305 or 310 as input/output devices respectively for the personal computers 335 and 345. When the media content reproduction device 305 or 310 are synchronized (Box 505) to their respective personal computers 335 and 345, the media content data reproduction software programs are activated. The media content data reproduction software programs are software music slave node media content reproduction devices such as iTunes from Apple Computer, Inc or Zune from Microsoft Inc. The unique song link identifier code is used by an online music store 360, which was saved earlier on media content storage device 315 or 330 of the media content reproduction device 305 or 310 will be loaded to the software automatically. The song link identifier code connects the user to the online music store 360 via the internet 355 such that the user can purchase (Box 510) the song directly. As above, once the purchase is completed, the user of the media content reproduction device 305 or 310 on which the selected digitized musical audio media content data file 317 or 332 is resident may receive (Box 515) store credit for his effort in sharing the selected digitized musical audio media content data file 317 or 332. The user of the media content reproduction device 305 or 310 that purchases the selected digitized musical audio media content data file 317 or 332 may also get store credit for using sharing concept to purchase song. This store credit allows the users to make music purchase in the future.

Returning to FIG. 3, the network controller 320 further monitors the digital rights management of the media content data files and will not store or retrieve files retained by the media content storage 315, if doing so violates the digital rights management agreements between the authors of the media content data files and the users of the master controller node media content reproduction device 305 slave node media content reproduction device and the users of the slave node media content reproduction devices 310a, 310b, . . . , and 310n. Also, to prevent, interception of the transmitted media content data files, the network controller 320 encrypts the media content data files with a unique encryption key (ID) that is known only to the member slave node media content reproduction devices of the multi-node media content distribution system of this invention. The users of the master controller node media content reproduction device 305 and/or the slave node media content reproduction devices 310a, 310b, . . . , and 310n will give the permission to share the media content data files. The network controllers 320 of each of the master controller node media content reproduction device 305 and the slave node media content reproduction devices 310a, 310b, . . . , and 310n employing the underlying communication protocol will negotiate and exchange the encryption key. Any undesired third party will not be able to “sniff” the content since it will not be able to acquire the encryption key.

While this invention has been particularly shown and described with reference to the preferred embodiments thereof, it will be understood by those skilled in the art that various changes in form and details may be made without departing from the spirit and scope of the invention.

The invention claimed is:

1. A multi-node media content distribution system for distribution of media content wirelessly, the multi-node media content distribution system comprising:
a plurality of media content reproduction devices communicating wirelessly as nodes in a network, where one of the media content reproduction devices is designated as a master controller node media content reproduction device for the network and provides the media content data files to the network as a server and all remaining media content reproduction devices are slaves to the master controller node and receive the media content data files;
the network comprising:
an application layer where all the media content reproduction devices appear to be able to share their media content data files with other media content reproduction devices in the network, and
a protocol layer in which the master controller node coordinate a communication channel access timing and distribution of the media content data files to and from the other media content reproduction devices in the network.

2. The multi-node media content distribution system of claim 1 wherein the network functions selectively in a broadcast mode, a server mode, or a peer-to-peer network mode.

3. The multi-node media content distribution system of claim 2 wherein when the network functions in the broadcast mode, the master controller node broadcasts the media content data files to the slave node media content reproduction devices of the network.

4. The multi-node media content distribution system of claim 2 wherein when the network functions in the server mode, each slave node media content reproduction device of the network requests separate media content data files from a media content data files list.

5. The multi-node media content distribution system of claim 4 wherein the media content data files list contains file names of the media content data files to be transferred from the master controller node media content reproduction device to each of the slave node media content reproduction devices.

6. The multi-node media content distribution system of claim 2 wherein the network functions in the peer-to-peer network mode the user of master controller node media content reproduction device and the slave node media content reproduction devices appear to be equals on a peer-to-peer network.

7. The multi-node media content distribution system of claim 6 wherein the media content data files list for the master controller node media content reproduction device and all the slave node media content reproduction devices are transferred equally to the master controller node media content reproduction device such that all the slave node media content reproduction devices and the master controller node media content reproduction device and all the slave node media content reproduction devices individually request media content data files.

8. The multi-node media content distribution system of claim 2 wherein the master controller node and the slave node media content reproduction devices each comprise:
a network controller including a transceiver for broadcasting the bidirectional communication between the master controller node and the slave node media content reproduction devices and an antenna connected to the transceiver for broadcasting the bidirectional communication as RF signals; and
a media content storage device in communication with the network controller for storing the media content data files;

9. The multi-node media content distribution system of claim 1 wherein the master controller node at initialization assigns a channel to each individual slave node media content reproduction devices.

10. The multi-node media content distribution system of claim 1 wherein the channel is a time slot in a time domain multiple access (TDMA) communication system or a separate frequency channel of an RF communication system.

11. The multi-node media content distribution system of claim 10 wherein the network controller receives commands from a user of the master controller node media content reproduction device to select the broadcast mode, the server mode, or the peer-to-peer network mode.

12. The multi-node media content distribution system of claim 11 wherein when the network functions in broadcast mode, the network controller of the master controller node media content reproduction device extracts a desired media content data file from the media content storage of the master controller node media content reproduction device and broadcasts the media content data files as an uncompressed digitized audio signal as the RF signal from the master controller node media content reproduction device to the slave node media content reproduction devices.

13. The multi-node media content distribution system of claim 12 wherein the media content data file is divided into transmission frames to be broadcast by network controller master controller node media content reproduction device such the each transmission frame is divided into digitized audio data sub-frames appended with control and synchronization data sub-frames.

14. The multi-node media content distribution system of claim 11 wherein when the network functions in the server mode and the peer-to-peer network mode, the network controller of master controller node media content reproduction device transmits a media content list describing the media content data files present in the media content storage of the master controller node media content reproduction device to each of the slave node media content data files.

15. The multi-node media content distribution system of claim 14 wherein when the network functions in the peer-to-peer network mode, each of the slave node media content reproduction devices transmits their media content lists describing the media content data files present in the media content storage of the slave node media content reproduction devices to the master controller node media content reproduction device, which then compiles the media content lists of the slave node media content reproduction devices and retransmits the compiled media content lists to all the slave node media content reproduction devices.

16. The multi-node media content distribution system of claim 15 wherein when the network functions in the peer-to-peer network mode and the master controller node media content reproduction device receives a request for media content data files resident on one of the slave node media content reproduction devices, the master controller node media content reproduction device requests the media content data files from the slave node media content reproduction devices retaining that file in its media content storage, wherein the network controller of the slave node media content reproduction device possessing the requested media content data files extracts the request media content data files from its media content storage device and transmits the media content data files to the master controller node media content reproduction device, wherein the master controller node media content reproduction device retransmits the requested media content data file to the requesting slave node media content reproduction device.

17. The multi-node media content distribution system of claim 15 wherein when the network functions in the server mode, the master controller node media content reproduction device acts as strictly a server providing on the media content data files residing in the media content storage of the master controller node media content reproduction device.

18. The multi-node media content distribution system of claim 11 wherein the master controller node media content reproduction device monitors a digital rights management of the media content data files and will not store or retrieve the media content data files retained by the media content storage, if doing so violates digital rights management agreements between authors of the media content data files and the users of the master controller node media content reproduction device and the users of the slave node media content reproduction devices.

19. The multi-node media content distribution system of claim 1 wherein the master controller node media content reproduction device encrypts the media content data files with a unique encryption key that is known only to the member media content reproduction devices of the multi-node media content distribution system to prevent, interception of the transmitted media content data files.

20. The multi-node media content distribution system of claim 19 wherein one of the media content reproduction devices provides the permission to share the media content data files and the plurality of media content reproduction devices negotiate and exchange the encryption key.

21. The multi-node media content distribution system of claim 1 wherein the media content data files are digitized musical files, digitized video files, digitized voice messaging files, text messaging files, or media content information files.

22. The multi-node media content distribution system of claim 1 wherein each of the media content data files have an associated media content information files.

23. The multi-node media content distribution system of claim 22 wherein each of the plurality of media content reproduction devices is in communication with an online music store.

24. The multi-node media content distribution system of claim 23 wherein one slave node media content reproduction device receives one media content data file and the associated media content information file from the master controller node media content reproduction device wherein, upon reproduction of the media content data file, the user of the one slave node media content reproduction device stores the associated media content information file.

25. The multi-node media content distribution system of claim 24 wherein the user of the one slave node media content reproduction device receiving the one media content data file selectively transfers the associated media content information file to the online music store to purchase the one media content data file designated of the associated media content information file.

26. The multi-node media content distribution system of claim 25 wherein the user of media content reproduction device that originally transferred the one media content data file receives store credit for the purchase of the one media content reproduction device for sharing the one media content data file.

27. The multi-node media content distribution system of claim 26 wherein the user of the one slave node media content reproduction device receiving the one media content data file receives store credit for purchasing the one media content reproduction device as a result of sharing the one media content data file.

28. The multi-node media content distribution system of claim 23 wherein at least one of the plurality of media content reproduction devices is in communication with an online music store wirelessly through a public or private communications network connected to the internet with the online music store connected to the internet.

29. The multi-node media content distribution system of claim 23 wherein at least one of the plurality of media content reproduction devices is in communication with an online music store through a link to a personal computer connected to the internet with the online music store connected to the internet, wherein the at least one of the plurality of media content reproduction devices is connected as an input/output device of the personal computer.

30. A method for distributing media content data files in a multi-node media content distribution network comprising the steps of:
transmitting and receiving polling signals to scan for a local master controller node by at least one media content reproduction device;
monitoring the RF channels by the at least one media content reproduction device on which the at least one media content reproduction devices are transmitting and receiving;
determining by the at least one media content reproduction device if a master controller node is present;
declaring the at least one media content reproduction device as a master controller node, when no master controller node is present;
transmitting and receiving polling signals to identify the declared master controller node media content reproduction device as a master of the multi-node media content distribution network;
scanning by the declared master controller node media content reproduction device for the presence of other media content reproduction devices present to join the multi-node media content distribution network.
determining by the declared master controller node media content reproduction device if at least one other media content reproduction device is present;
establishing a communication channel between the declared master controller node media content reproduction device and at least one other media content reproduction device;
assigning an operational mode for the multi-node media content distribution network by the declared master controller node media content reproduction device;
distributing the media content data files between the declared master controller node media content reproduction device and the at least one other media content reproduction device present on the multi-node media content distribution network.

31. The method of distributing media content data files of claim 30 wherein the communication channel is a time slot for TDMA transmission or an RF channel for RF transmission.

32. The method of distributing media content data files of claim 30 wherein the operational mode is a broadcast mode, a server mode, or a peer-to-peer network mode.

33. The method of distributing media content data files of claim 32 wherein assigning an operational mode for the multi-node media content distribution network places the multi-node media content distribution network in the broadcast mode, the method of distributing media content data files further comprises the step of broadcasting the media content data files from the master controller node media content reproduction device to the at least one other media content reproduction device for reproduction.

34. The method of distributing media content data files of claim 32 wherein, assigning an operational mode for the multi-node media content distribution network places the multi-node media content distribution network in the server mode, the method of distributing media content data files further comprises the steps of:
transmitting by the master controller node media content reproduction device a media content data file list detailing the content media data files retained by the master controller node on its media content storage;
requesting by one media content reproduction device a desired media content data files; and
formatting and transmitting the media content data file by the master controller node media content reproduction device to the requesting one media content reproduction device.

35. The method of distributing media content data files of claim 32 wherein, assigning an operational mode for the multi-node media content distribution network places the multi-node media content distribution network in the peer-to-peer network mode, the method of distributing media content data files further comprises the steps of:
transmitting a media content data file list for the master controller node media content reproduction device to the at least one other media content reproduction device;
providing a media content data file list for at least one other media content reproduction device of the peer-to-peer network;
retransmitting by the master controller node media content reproduction device the media content data file list of the at least one other media content reproduction device to all peer media content reproduction devices present on the multi-node media content distribution system;
requesting by at least one peer media content reproduction device a desired distributing media content data files;
determining if the desired distributing media content data files is resident on the master controller node media content reproduction device or one of the at least one other peer media content reproduction devices;
requesting by the master controller node media content reproduction device the desired media content data files from the peer media content reproduction device retaining the desired media content data files;
transmitting the desired media content data files to the master controller node media content reproduction device, when the desired media content data files are resident on the peer media content reproduction device; and
retransmitting the desired media content data files from the master controller node media content reproduction device to the requesting at least one other media content reproduction device.

36. The method of distributing media content data files of claim 30 further comprising the steps of:
monitoring a digital rights management of the media content data files by the master controller node media content reproduction device; and
not storing or retrieving the media content data files retained within the multi-node media content distribution network, if doing so violates digital rights management agreements between authors of the media content data files and the users of the master controller node media content reproduction device and the users of the at least one other media content reproduction devices.

37. The method of distributing media content data files of claim 30 further comprises the step of encrypting by the master controller node media content reproduction device the media content data files with a unique encryption key that is known only to the member media content reproduction devices of the multi-node media content distribution system to prevent, interception of the transmitted media content data files.

38. The method of distributing media content data files of claim 37 further comprising the steps of:
providing by one of the media content reproduction devices of the multi-node media content distribution network permission to share the media content data files; and
negotiating and exchanging the unique encryption key for the encrypted media content data files among the master controller node media content reproduction device and the at least one other media content reproduction devices.

39. The method of distributing media content data files of claim 30 wherein each of the media content data files have an associated media content information file.

40. The method of distributing media content data files of claim 39 further comprising the step of communicating between at least one of each of the plurality of media content reproduction devices an online music store.

41. The method of distributing media content data files of claim 40 further comprising the steps of:
transferring one media content data file and the associated media content information file to one slave node media content reproduction device from the master controller node media content reproduction device; and
storing the associated media content information file by the user of the one slave node media content reproduction device.

42. The method of distributing media content data files of claim 41 further comprising the steps of:
selectively transferring the associated media content information file to the online music store by the user of the one slave node media content reproduction device receiving the one media content data file; and
purchasing the one media content data file designated of the associated media content information file.

43. The method of distributing media content data files of claim 42 further comprising the step receiving a store credit by the user of media content reproduction device originally containing the one media content data file for the purchase of the one media content reproduction device for sharing the one media content data file.

44. The method of distributing media content data files of claim 43 receiving a store credit by the user of the one slave node media content reproduction device receiving the one media content data file for purchasing the one media content reproduction device as a result of sharing the one media content data file.

45. The method of distributing media content data files of claim 30 wherein at least one of the plurality of media content reproduction devices is in communication with an online music store wirelessly through a public or private communications network connected to the internet with the online music store connected to the internet.

46. The method of distributing media content data files of claim 30 wherein at least one of the plurality of media content reproduction devices is in communication with an online music store through a link to a personal computer connected to the internet with the online music store connected to the internet, wherein the at least one of the plurality of media content reproduction devices is connected as an input/output device of the personal computer.

47. A multi-node media content distribution system for distribution of media content wirelessly within a vicinity, the multi-node media content distribution system comprising:
a plurality of media content reproduction devices communicating wirelessly configured as a network where one of the media content reproduction devices is a master controller node media content reproduction device for the network and all remaining media content reproduction devices are slave nodes, such that the master controller node media content reproduction device provides the media content data files with associated media content information files to the network as a server and the slave nodes receive the media content data files associated media content information files;
wherein at least one of the plurality of media content reproduction devices is in communication with an online music store for purchase of a selected media content data file based on the associated media content information file.

48. The multi-node media content distribution system of claim 47 wherein the network comprises:
an application layer where all the media content reproduction devices appear to be able to share their media content data files with other media content reproduction devices in the network, and
a protocol layer in which the master controller node coordinate a communication channel access timing and distribution of the media content data files to and from the other media content reproduction devices in the network.

49. The multi-node media content distribution system of claim 47 wherein the network functions selectively in a broadcast mode, a server mode, or a peer-to-peer network mode.

50. The multi-node media content distribution system of claim 49 wherein when the network functions in the broadcast mode, the master controller node broadcasts the media content data files to the slave node media content reproduction devices of the network.

51. The multi-node media content distribution system of claim 49 wherein when the network functions in the server mode, each slave node media content reproduction device of the network requests separate media content data files from a media content data files list.

52. The multi-node media content distribution system of claim 51 wherein the media content data files list contains file names of the media content data files to be transferred from the master controller node media content reproduction device to each of the slave node media content reproduction devices.

53. The multi-node media content distribution system of claim 49 wherein the network functions in the peer-to-peer network mode the user of master controller node media content reproduction device and the slave node media content reproduction devices appear to be equals on a peer-to-peer network.

54. The multi-node media content distribution system of claim 53 wherein the media content data files list for the master controller node media content reproduction device and all the slave node media content reproduction devices are transferred equally to the master controller node media content reproduction device and all the slave node media content reproduction devices and the master controller node media content reproduction device and all the slave node media content reproduction devices individually request media content data files.

55. The multi-node media content distribution system of claim 49 wherein the master controller node and the slave node media content reproduction devices each comprise:
a network controller including a transceiver for broadcasting the bidirectional communication between the master controller node and the slave node media content reproduction devices and an antenna connected to the transceiver for broadcasting the bidirectional communication as RF signals; and
a media content storage device in communication with the network controller for storing the media content data files;

56. The multi-node media content distribution system of claim 47 wherein the master controller node at initialization assigns a channel to each individual slave node media content reproduction devices.

57. The multi-node media content distribution system of claim 47 wherein the channel is a time slot in a time domain multiple access (TDMA) communication system or a separate frequency channel of an RF communication system.

58. The multi-node media content distribution system of claim 57 wherein the network controller receives commands from a user of the master controller node media content reproduction device to select the broadcast mode, the server mode, or the peer-to-peer network mode.

59. The multi-node media, content distribution system of claim 58 wherein when the network functions in broadcast mode, the network controller of the master controller node media content reproduction device extracts a desired media content data file from the media content storage of the master controller node media content reproduction device and broadcasts the media content data files as an uncompressed digitized audio signal as the RF signal from the master controller node media content reproduction device to the slave node media content reproduction devices.

60. The multi-node media content distribution system of claim 59 wherein the media content data file is divided into transmission frames to be broadcast by network controller master controller node media content reproduction device such the each transmission frame is divided into digitized audio data sub-frames appended with control and synchronization data sub-frames.

61. The multi-node media content distribution system of claim 57 wherein when the network functions in the server mode and the peer-to-peer network mode, the network controller of master controller node media content reproduction device transmits a media content list describing the media content data files present in the media content storage of the master controller node media content reproduction device to each of the slave node media content data files.

62. The multi-node media content distribution system of claim 61 wherein when the network functions in the peer-to-peer network mode, each of the slave node media content reproduction devices transmits their media content lists describing the media content data files present in the media content storage of the slave node media content reproduction devices to the master controller node media content reproduction device, which then compiles the media content lists of the slave node media content reproduction devices and retransmits the compiled media content lists to all the slave node media content reproduction devices.

63. The multi-node media content distribution system of claim 62 wherein when the network functions in the peer-to-peer network mode and the master controller node media content reproduction device receives a request for media content data files resident on one of the slave node media content reproduction devices, the master controller node media content reproduction device requests the media content data files from the slave node media content reproduction devices retaining that file in its media content storage, wherein the network controller of the slave node media content reproduction device possessing the requested media content data files extracts the request media content data files from its media content storage device and transmits the media content data files to the master controller node media content reproduction device, wherein the master controller node media content reproduction device retransmits the requested media content data file to the requesting slave node media content reproduction device.

64. The multi-node media content distribution system of claim 63 wherein when the network functions in the server mode, the master controller node media content reproduction device acts as strictly a server providing on the media content data files residing in the media content storage of the master controller node media content reproduction device.

65. The multi-node media content distribution system of claim 57 wherein the master controller node media content reproduction device monitors a digital rights management of the media content data files and will not store or retrieve the media content data files retained by the media content storage, if doing so violates digital rights management agreements between authors of the media content data files and the users of the master controller node media content reproduction device and the users of the slave node media content reproduction devices.

66. The multi-node media content distribution system of claim 47 wherein the master controller node media content reproduction device encrypts the media content data files with a unique encryption key that is known only to the member media content reproduction devices of the multi-node media content distribution system to prevent, interception of the transmitted media content data files.

67. The multi-node media content distribution system of claim 66 wherein one of the media content reproduction devices provides the permission to share the media content data files and the plurality of media content reproduction devices negotiate and exchange the encryption key.

68. The multi-node media content distribution system of claim 47 wherein the media content data files are digitized musical files, digitized video files, digitized voice messaging files, or text messaging files.

69. The multi-node media content distribution system of claim 47 wherein one slave node media content reproduction device receives one media content data file and the associated media content information file from the master controller node media content reproduction device wherein, upon reproduction of the media content data file, the user of the one slave node media content reproduction device stores the associated media content information file.

70. The multi-node media content distribution system of claim 69 wherein the user of the one slave node media content reproduction device receiving the one media content data file selectively transfers the associated media content information file to the online music store to purchase the one media content data file designated of the associated media content information file.

71. The multi-node media content distribution system of claim 70 wherein the user of media content reproduction device that originally transferred the one media content data file receives store credit for the purchase of the one media content reproduction device for sharing the one media content data file.

72. The multi-node media content distribution system of claim 71 wherein the user of the one slave node media content reproduction device receiving the one media content data file receives store credit for purchasing the one media content reproduction device as a result of sharing the one media content data file.

73. The multi-node media content distribution system of claim 69 wherein at least one of the plurality of media content reproduction devices is in communication with an online music store wirelessly through a public or private communications network connected to the internet with the online music store connected to the internet.

74. The multi-node media content distribution system of claim 69 wherein at least one of the plurality of media content reproduction devices is in communication with an online music store through a link to a personal computer connected to the internet with the online music store connected to the internet, wherein the at least one of the plurality of media content reproduction devices is connected as an input/output device of the personal computer.
